(19) United States
(12) Patent Application Publication
(10) Pub. No.: US 2026/0029986 A1
(43) Pub. Date: Jan. 29, 2026

(54) INFORMATION PROCESSING DEVICE AND INFORMATION PROCESSING METHOD

(71) Applicant: Panasonic Automotive Systems Co., Ltd., Kanagawa (JP)

(72) Inventors: Kosuke KUBOTA, Kanagawa (JP); Hiroshi KONO, Kanagawa (JP)

(73) Assignee: Panasonic Automotive Systems Co., Ltd., Kanagawa (JP)

(21) Appl. No.: 19/242,407

(22) Filed: Jun. 18, 2025

(30) Foreign Application Priority Data
Jul. 23, 2024 (JP) 2024-117709

(51) Int. Cl. G06F 3/16; G06F 1/3234

(52) U.S. Cl. CPC G06F 3/165; G06F 1/325

(57) ABSTRACT

An information processing device includes first and second output circuits and a control circuit. The first output circuit outputs a first video included in a first video/audio to a first display region, and outputs a first audio included in the first video/audio to a first wireless communication circuit that outputs an audio to a first audio output device by wireless communication. The second output circuit outputs a second video included in a second video/audio to a second display region, and outputs a second audio included in the second video/audio to a second wireless communication circuit that outputs an audio to a second audio output device by wireless communication. When it is determined that the first video/audio and the second video/audio are the same video/audio, the control circuit operates the second wireless communication circuit in the power saving mode.

### CROSS-REFERENCE TO RELATED APPLICATIONS

This application is based upon and claims the benefit of priority from Japanese Patent Application No. 2024-117709, filed on Jul. 23, 2024, the entire contents of which are incorporated herein by reference.

### FIELD

Embodiments described herein relate generally to an information processing device and an information processing method.

### BACKGROUND

There is known a system that connects a plurality of wireless communication circuits and audio output devices such as a speaker and a headphone, and outputs audio included in video/audio to the audio output devices connected via the plurality of wireless communication circuits by wireless communication (for example, JP 5115775 B2 and WO 2023/079682 A).

However, in the related art, because the audio is constantly output from the plurality of wireless communication circuits to the audio output device wirelessly connected to the respective wireless communication circuits, power consumption may increase.

An object of the present disclosure is to provide an information processing device and an information processing method capable of reducing power consumption.

### SUMMARY

An information processing device according to an embodiment of the present disclosure includes first and second output circuits and a control circuit. The first output circuit is configured to output a first video included in a first video/audio to a first display region, and output a first audio included in the first video/audio to a first wireless communication circuit that outputs an audio to a first audio output device by wireless communication. The second output circuit is configured to output a second video included in a second video/audio to a second display region, and output a second audio included in the second video/audio to a second wireless communication circuit that outputs an audio to a second audio output device by wireless communication. The control circuit is configured to operate the second wireless communication circuit in a power saving mode when it is determined that the first video/audio and the second video/audio are a same video/audio.

### BRIEF DESCRIPTION OF THE DRAWINGS

FIG. 1 is a schematic diagram illustrating an example of a system according to an embodiment;

FIG. 2 is a hardware configuration diagram;

FIG. 3 is a block diagram illustrating an example of a functional configuration of the system;

FIG. 4 is a flowchart illustrating an example of a flow of information processing executed by an information processing device;

FIG. 5 is a schematic diagram illustrating an example of a system according to a modified example;

FIG. 6 is a schematic diagram illustrating an example of a system according to a modified example;

FIG. 7 is a block diagram illustrating an example of a functional configuration of the system; and

FIG. 8 is a schematic diagram illustrating an example of a system according to a modified example.

### DETAILED DESCRIPTION

Hereinafter, embodiments of an information processing device and an information processing method according to the present disclosure will be described with reference to the accompanying drawings.

### First Embodiment

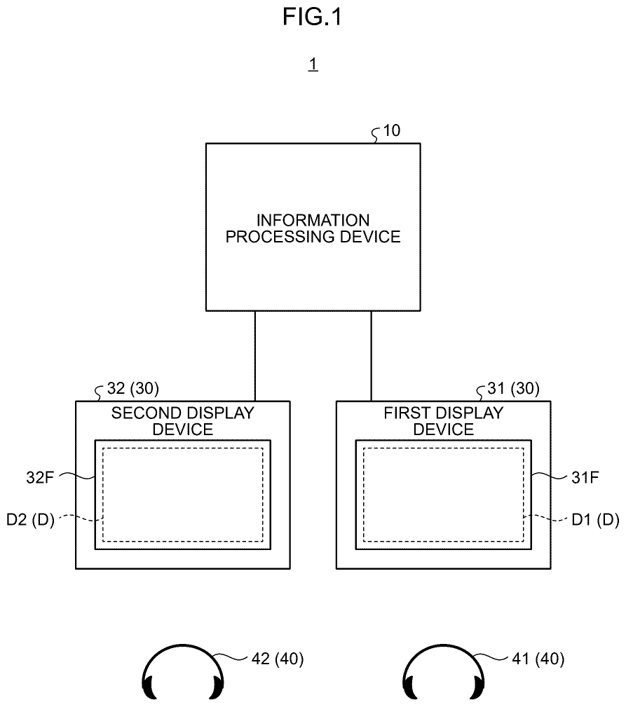

FIG. 1 is a schematic diagram illustrating an example of a system 1 according to the present embodiment. In the present embodiment and modified examples, the same functions are denoted by the same reference sign, and a detailed description thereof will be omitted.

The system 1 includes an information processing device 10, one or more display devices 30, and a plurality of audio output devices 40. The information processing device 10 and the display device 30 are communicably connected to each other. At least one of the information processing device 10 and the display device 30 is communicably connected to the audio output device 40 by wireless communication (details thereof are described below).

The information processing device 10 is a dedicated or general-purpose computer that performs control to output an audio included in a video/audio to the plurality of audio output devices 40 by wireless communication and output a video included in the video/audio to a display region D of the display device 30.

The video/audio refers to data including a video signal and an audio signal. In the present embodiment, the video signal is simply referred to as a video, and the audio signal is simply referred to as audio. Examples of the video/audio include moving image data, television broadcast data, and various audio visual (AV) contents.

The display device 30 is an apparatus including at least a display panel such as a display and having at least a function of displaying the video. In the present embodiment, a mode in which the system 1 includes a first display device 31 and a second display device 32 as the display devices 30 will be described as an example. The first display device 31 includes at least a first display panel 31F that displays various videos. The second display device 32 includes at least a second display panel 32F that displays various videos. The video is displayed in each of a first display region D1 of the first display device 31 and a second display region D2 of the second display device 32. The first display region D1 and the second display region D2 are examples of the display region D.

The audio output device 40 is an apparatus that outputs the audio received by wireless communication. The audio output device 40 is a Bluetooth terminal capable of Bluetooth communication, such as a Bluetooth (registered trademark) speaker, a wireless earphone, or a wireless headphone.

A mode in which the system 1 according to the present embodiment includes a first audio output device 41 and a second audio output device 42 as the plurality of audio output devices 40 will be described as an example. The first audio output device 41 and the second audio output device 42 are examples of the audio output device 40.

The system 1 according to the present embodiment can be applied to various targets. For example, the system 1 is applied to a rear seat entertainment system (RSE). In a case where the system 1 is applied to the RSE, the first display panel 31F of the first display device 31 and the second display panel 32F of the second display device 32 are provided, for example, on back surfaces of a driver's seat and a passenger's seat of a vehicle. In this case, the first display panel 31F and the second display panel 32F can be viewed and operated by users on rear seats. The application target of the system 1 is not limited to the RSE.

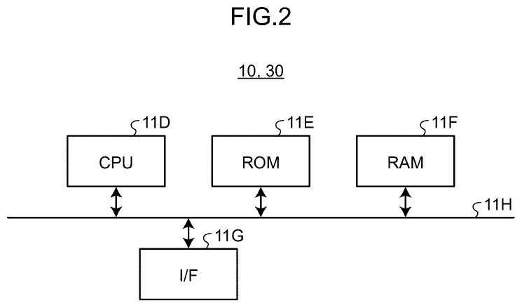

FIG. 2 is a hardware configuration diagram illustrating an example of the information processing device 10 and the display device 30.

The information processing device 10 and the display device 30 each have a hardware configuration using a normal computer in which a central processing unit (CPU) 11D, a read only memory (ROM) 11E, a random access memory (RAM) 11F, an interface (I/F) 11G, and the like are connected to each other by a bus 11H.

The CPU 11D is an arithmetic apparatus that controls the information processing device 10 and the display device 30. The ROM 11E stores a program or the like that implements various types of processing executed by the CPU 11D. The RAM 11F stores data necessary for various types of processing executed by the CPU 11D. The I/F 11G is an interface for transmitting and receiving data.

A program for executing information processing executed by the information processing device 10 and the display device 30 is provided by being incorporated in the ROM 11E or the like in advance. The program executed by the information processing device 10 and the display device 30 may be provided by being recorded in a computer-readable recording medium such as a CD-ROM, a flexible disk (FD), a CD-R, or a digital versatile disc (DVD) as a file in a format installable or executable in the information processing device 10 and the display device 30.

Next, the system 1 will be described in detail.

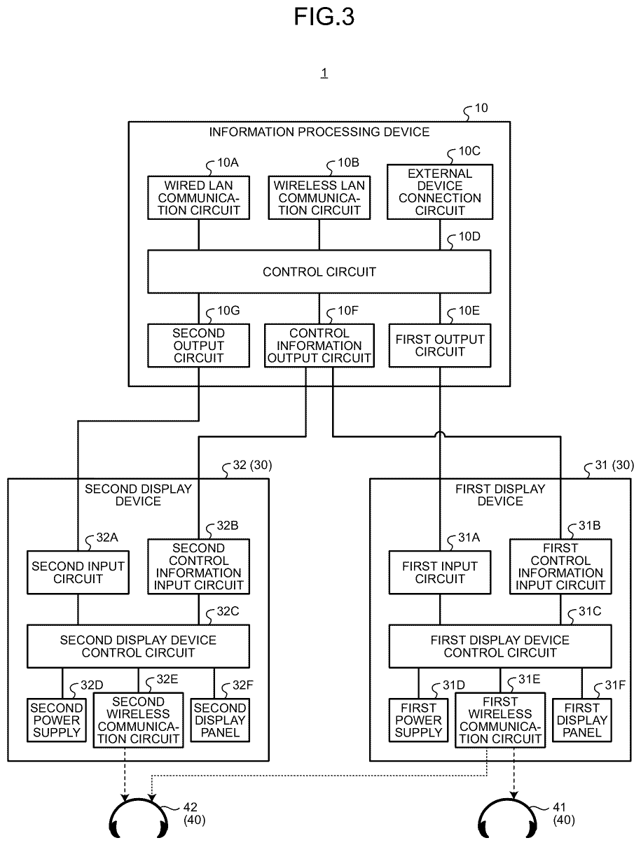

FIG. 3 is a block diagram illustrating an example of a functional configuration of the system 1.

The system 1 includes the information processing device 10, the second display device 32, the first display device 31, the first audio output device 41, and the second audio output device 42. The information processing device 10 is communicably connected to each of the first display device 31 and the second display device 32.

First, the first display device 31 and the second display device 32 will be described.

The first display device 31 is an example of the display device 30. The first display device 31 includes a first input circuit 31A, a first control information input circuit 31B, a first display device control circuit 31C, a first power supply 31D, a first wireless communication circuit 31E, and the first display panel 31F.

The first input circuit 31A, the first control information input circuit 31B, the first power supply 31D, the first wireless communication circuit 31E, and the first display panel 31F are connected to the first display device control circuit 31C so as to be able to exchange data or a signal.

The first input circuit 31A is communicably connected to a first output circuit 10E of the information processing device 10 on a one-to-one basis. The first input circuit 31A receives a first video/audio from the first output circuit 10E of the information processing device 10, and outputs the first video/audio to the first display device control circuit 31C. The first video/audio is an example of the video/audio.

The first control information input circuit 31B is communicably connected to a control information output circuit 10F of the information processing device 10. The first control information input circuit 31B receives various types of control information output under the control of a control circuit 10D from the control information output circuit 10F, and outputs the control information to the first display device control circuit 31C.

The first power supply 31D supplies power to each unit of the first display device 31. The first power supply 31D is configured to be switchable so as to supply the power to each unit of the first display device 31 or cut off the supply of the power according to an operation instruction from the user, the control information received from the information processing device 10, or the like.

The first wireless communication circuit 31E outputs the audio to the audio output device 40 by wireless communication. The first wireless communication circuit 31E performs Bluetooth communication with the audio output device 40 capable of Bluetooth communication.

The first wireless communication circuit 31E supports at least one of a multicast protocol and a broadcast protocol, and performs transmission and reception (bidirectional communication) of a multicast audio and transmission and reception of a broadcast audio by wireless communication. The first wireless communication circuit 31E can receive signals from the plurality of audio output devices 40.

The first wireless communication circuit 31E wirelessly communicates with the audio output device 40 by Bluetooth Low Energy (LE) Audio. The Bluetooth LE Audio is a standard of Bluetooth audio that can simultaneously perform Bluetooth communication with the plurality of audio output devices 40. Therefore, the first wireless communication circuit 31E is configured to be able to perform one-to-many wireless communication with the plurality of audio output devices 40.

In the present embodiment, in an initial state, the first wireless communication circuit 31E outputs the audio to the first audio output device 41 by wireless communication under the control of the first display device control circuit 31C. In addition, the first wireless communication circuit 31E outputs the audio to the first audio output device 41 and the second audio output device 42 by wireless communication under the control of the first display device control circuit 31C. Details of such controls are described below.

In the present embodiment, a mode in which the first wireless communication circuit 31E outputs the audio to the audio output devices 40 by multicasting using the multicast protocol will be described as an example. Therefore, the description will be given assuming a case where the first wireless communication circuit 31E is pre-paired with the first audio output device 41 and the second audio output device 42. A mode in which the first wireless communication circuit 31E outputs the audio to the audio output device 40 by broadcasting using the broadcast protocol is also applicable.

The first display panel 31F is a display such as a liquid crystal display or an organic electro-luminescence (EL) display. In the present embodiment, the video is displayed in the first display region D1 of the first display panel 31F (see also FIG. 1). The first display region D1 is an example of the display region D, and is a region where the video is displayed. The display region D may also be referred to as a display screen.

The first display device control circuit 31C controls at least one of the first display panel 31F and the first wireless communication circuit 31E according to the control information received from the information processing device 10. For example, the first display device control circuit 31C outputs, to the first display region D1 of the first display panel 31F, a first video included in the first video/audio received from the first output circuit 10E via the first input circuit 31A according to the control information. Further, the first display device control circuit 31C controls the first wireless communication circuit 31E to output, to the audio output device 40, a first audio included in the first video/audio received from the first output circuit 10E via the first input circuit 31A according to the control information. Details of the control performed by the first display device control circuit 31C are described below.

The second display device 32 is an example of the display device 30. The second display device 32 is the display device 30 that is configured separately from the first display device 31, and has the same configuration as that of the first display device 31.

Specifically, the second display device 32 includes a second input circuit 32A, a second control information input circuit 32B, a second display device control circuit 32C, a second power supply 32D, a second wireless communication circuit 32E, and the second display panel 32F.

The second input circuit 32A, the second control information input circuit 32B, the second power supply 32D, the second wireless communication circuit 32E, and the second display panel 32F are connected to the second display device control circuit 32C so as to be able to exchange data or a signal.

The second input circuit 32A is communicably connected to a second output circuit 10G of the information processing device 10 on a one-to-one basis. The second input circuit 32A receives a second video/audio from the second output circuit 10G of the information processing device 10, and outputs the second video/audio to the second display device control circuit 32C. The second video/audio is an example of the video/audio.

The second control information input circuit 32B is communicably connected to the control information output circuit 10F of the information processing device 10. The second control information input circuit 32B receives various types of control information output under the control of the control circuit 10D from the control information output circuit 10F, and outputs the control information to the second display device control circuit 32C.

The second power supply 32D supplies power to each unit of the second display device 32. The second power supply 32D is configured to be switchable so as to supply the power to each unit of the second display device 32 or cut off the supply of the power according to an operation instruction from the user, the control information received from the information processing device 10, or the like.

The second wireless communication circuit 32E outputs the audio to the audio output device 40 by wireless communication. Similarly to the first wireless communication circuit 31E, the second wireless communication circuit 32E performs Bluetooth communication with the audio output device 40 capable of Bluetooth communication.

The second wireless communication circuit 32E supports at least one of the multicast protocol and the broadcast protocol, similarly to the first wireless communication circuit 31E. The second wireless communication circuit 32E performs transmission and reception of the multicast audio and transmission and reception of the broadcast audio by wireless communication. The second wireless communication circuit 32E can receive signals from the plurality of audio output devices 40.

Similarly to the first wireless communication circuit 31E, the second wireless communication circuit 32E wirelessly communicates with the audio output device 40 by Bluetooth LE Audio. Therefore, the second wireless communication circuit 32E is configured to be able to perform one-to-many wireless communication with the plurality of audio output devices 40.

In the present embodiment, in an initial state, the second wireless communication circuit 32E outputs the audio to the second audio output device 42 by wireless communication under the control of the second display device control circuit 32C. Further, the second wireless communication circuit 32E is switched to a power saving mode under the control of the second display device control circuit 32C.

The power saving mode is a mode in which at least the output of the audio is stopped. The second wireless communication circuit 32E switched to the power saving mode is in a state in which wireless communication is stopped. The second display device control circuit 32C controls the second wireless communication circuit 32E so as to stop the output of the audio to the audio output device 40, or performs control to cut off the power supplied to the second wireless communication circuit 32E. With such controls, the second display device control circuit 32C controls the second wireless communication circuit 32E to operate in the power saving mode.

In the present embodiment, a mode in which the second wireless communication circuit 32E outputs the audio to the audio output devices 40 by multicasting using the multicast protocol similarly to the first wireless communication circuit 31E will be described as an example. In the present embodiment, the description will be given assuming a case where the second wireless communication circuit 32E is pre-paired with at least the second audio output device 42. A mode in which the second wireless communication circuit 32E outputs the audio to the audio output device 40 by broadcasting using the broadcast protocol is also applicable.

The second display panel 32F is a display such as a liquid crystal display or an organic EL display. In the present embodiment, the video is displayed in the second display region D2 of the second display panel 32F (see also FIG. 1). The second display region D2 is an example of the display region D, and is a region where the video is displayed.

The second display device control circuit 32C controls at least one of the second display panel 32F and the second wireless communication circuit 32E according to the control information received from the information processing device 10. For example, the second display device control circuit 32C outputs, to the second display region D2 of the second display panel 32F, a second video included in the second video/audio received from the second output circuit 10G via the second input circuit 32A according to the control information. In addition, the second display device control circuit 32C controls the second wireless communication circuit 32E to output, to the second audio output device 42, a second audio included in the second video/audio received from the second output circuit 10G via the second input circuit 32A according to the control information. The second display device control circuit 32C operates the second wireless communication circuit 32E in the power saving mode according to the control information. Details of the control performed by the second display device control circuit 32C are described below.

Next, the information processing device 10 according to the present embodiment will be described in detail.

The information processing device 10 includes a wired local area network (LAN) communication circuit 10A, a wireless LAN communication circuit 10B, an external device connection circuit 10C, the control circuit 10D, the first output circuit 10E, the control information output circuit 10F, and the second output circuit 10G. The wired LAN communication circuit 10A, the wireless LAN communication circuit 10B, the external device connection circuit 10C, the first output circuit 10E, the control information output circuit 10F, and the second output circuit 10G are communicably connected to the control circuit 10D.

The wired LAN communication circuit 10A is connected to the Internet via a gateway or the like, and transmits and receives data such as the video/audio to and from a server. Furthermore, the wired LAN communication circuit 10A is connected to a set top box (STB) or the like, and receives the video/audio of cable broadcasting, satellite broadcasting, terrestrial television broadcasting, Internet protocol (IP) broadcasting (broadband, video on demand (VOD), or the like from the STB.

The wireless LAN communication circuit 10B transmits and receives data to and from a wireless communication device such as a smartphone or a tablet. The wireless LAN communication circuit 10B can also be connected to the Internet through an access point or the like.

The external device connection circuit 10C communicates with an external device in a wireless or wired manner. The external device is, for example, a device that transmits and receives the video signal in an uncompressed manner by high-definition multimedia interface (HDMI) (registered trademark) or the like, and is a personal computer, a projector, a home theater device, or the like.

The first output circuit 10E is connected to the first input circuit 31A of the first display device 31 on a one-to-one basis, and outputs the first video/audio to the first display device 31. The second output circuit 10G is connected to the second input circuit 32A of the second display device 32 on a one-to-one basis, and outputs the second video/audio to the second display device 32. The first video/audio and the second video/audio are examples of the video/audio.

The control information output circuit 10F outputs the control information to the display device 30 under the control of the control circuit 10D.

The control circuit 10D executes various types of information processing in the information processing device 10. For example, in the control circuit 10D, the CPU 11D reads a program from the ROM 11E onto the RAM 11F and executes the program, whereby each functional unit of a processor 20 described below is implemented on a computer.

For example, a part of or the entire control circuit 10D may be implemented by causing a processing apparatus such as the CPU 11D to execute a program, that is, in software, may be implemented in hardware such as an integrated circuit (IC), or may be implemented by using software and hardware in combination. Furthermore, at least one of the functional units that execute processing in 20D may be mounted on an external information processing device communicably connected to the information processing device 10 via a network or the like.

The control circuit 10D acquires a plurality of video/audios to be output to the display device 30 from at least one of the wired LAN communication circuit 10A, the wireless LAN communication circuit 10B, and the external device connection circuit 10C. Furthermore, the control circuit 10D may acquire the plurality of video/audios to be output to the display device 30 from a storage unit provided in the information processing device 10. In the present embodiment, a mode in which the control circuit 10D acquires the first video/audio and the second video/audio as the video/audios to be output to the display device 30 will be described as an example.

The control circuit 10D outputs the first video/audio to the first output circuit 10E. The first output circuit 10E outputs the first video included in the first video/audio to the first display region D1, and outputs the first audio included in the first video/audio to the first wireless communication circuit 31E.

The control circuit 10D outputs the second video/audio to the second output circuit 10G. The second output circuit 10G outputs the second video included in the second video/audio to the second display region D2, and outputs the second audio included in the second video/audio to the second wireless communication circuit 32E.

The control circuit 10D determines whether or not the first video/audio and the second video/audio are the same video/audio. It is sufficient if the control circuit 10D determines whether or not the two video/audios are the same video/audio by a known method.

In a case where it is determined that the first video/audio and the second video/audio are the same video/audio, the control circuit 10D operates the second wireless communication circuit 32E in the power saving mode. Specifically, the control circuit 10D outputs a control signal indicating that the second wireless communication circuit 32E is to operate in the power saving mode to the second control information input circuit 32B via the control information output circuit 10F.

The second display device control circuit 32C of the second display device 32 that has received the control signal from the control information output circuit 10F via the second control information input circuit 32B switches the second wireless communication circuit 32E to the power saving mode. Specifically, the second display device control circuit 32C that has received the control signal controls the second wireless communication circuit 32E to stop the output of the audio to the audio output device 40, or controls the second power supply 32D to cut off the power supplied to the second wireless communication circuit 32E. With such controls, the second display device control circuit 32C switches the second wireless communication circuit 32E to the power saving mode.

By operating the second wireless communication circuit 32E in the power saving mode, wireless communication connection between the second wireless communication circuit 32E and the second audio output device 42 is released, and the output of the second audio from the second wireless communication circuit 32E to the second audio output device 42 is stopped.

Then, the control circuit 10D controls the first wireless communication circuit 31E to output the first audio included in the first video/audio to the first audio output device 41 and the second audio output device 42.

Therefore, in a case where it is determined that the first video/audio and the second video/audio are the same video/audio, the second wireless communication circuit 32E is switched to the power saving mode, and the first audio is output from the first wireless communication circuit 31E to the first audio output device 41 and the second audio output device 42.

Here, priority information indicating a priority degree of a wireless communication circuit that is a wireless communication connection target may be registered in advance in each of the first audio output device 41 and the second audio output device 42.

In the present embodiment, wireless communication circuit identification information for identifying the first wireless communication circuit 31E is registered in advance in the first audio output device 41 in association with first priority information indicating the highest priority of “1”. Further, wireless communication circuit identification information for identifying the second wireless communication circuit 32E is registered in advance in the first audio output device 41 in association with second priority information indicating the next priority of “2”.

In addition, the wireless communication circuit identification information for identifying the second wireless communication circuit 32E is registered in advance in the second audio output device 42 in association with the first priority information indicating the highest priority of “1”. Further, the wireless communication circuit identification information for identifying the first wireless communication circuit 31E is registered in the second audio output device 42 in advance in association with the second priority information indicating the next priority of “2”.

The first priority information and the second priority information are examples of the priority information.

Then, in a case where the first audio output device 41 and the second audio output device 42 can receive the audio from each of the first wireless communication circuit 31E and the second wireless communication circuit 32E by wireless communication, the audio is received from one wireless communication circuit having a higher priority and is output. In addition, in a case where the first audio output device 41 and the second audio output device 42 cannot receive the audio from the wireless communication circuit with the highest priority, the audio is received from a wireless communication circuit with the next priority.

It is assumed that the second wireless communication circuit 32E is in the power saving mode and the output of the second audio from the second wireless communication circuit 32E by wireless communication is stopped. In this case, the second audio output device 42 cannot receive the second audio from the second wireless communication circuit 32E identified by the wireless communication circuit identification information associated with priority degree information indicating a higher priority degree. In other words, the second audio output device 42 is in a state in which the reception of the second audio from the second wireless communication circuit 32E identified by the wireless communication circuit identification information associated with the first priority information indicating the highest priority of “1” is stopped.

In this case, the second audio output device 42 receives the first audio from the first wireless communication circuit 31E identified by the wireless communication circuit identification information associated with the priority degree information indicating a lower priority degree. Specifically, the second audio output device 42 receives the first audio from the first wireless communication circuit 31E identified by the wireless communication circuit identification information associated with the second priority information indicating the next priority of “2” and outputs the first audio.

Therefore, in a case where the priority information is registered in advance in the audio output device 40, the control circuit 10D can control the first wireless communication circuit 31E to output the first audio included in the first video/audio to the first audio output device 41 and the second audio output device 42 by operating the second wireless communication circuit 32E in the power saving mode. That is, in a case where the priority information is registered in advance in the audio output device 40, the control circuit 10D can control the first wireless communication circuit 31E to output the first audio included in the first video/audio to the first audio output device 41 and the second audio output device 42 by simple control.

A mode in which the priority information indicating the priority degree of the wireless communication circuit that is the wireless communication connection target is not registered in advance in each of the first audio output device 41 and the second audio output device 42 is also applicable.

In this case, in a case where it is determined that the first video/audio and the second video/audio are the same video/audio, the control circuit 10D operates the second wireless communication circuit 32E in the power saving mode and transmits, to the first display device 31, the control information for controlling the first wireless communication circuit 31E to output the first audio to the first audio output device 41 and the second audio output device 42.

Specifically, before it is determined that the first video and the second video are the same video, that is, in the initial state, the control circuit 10D controls the first wireless communication circuit 31E to output the first audio to the first audio output device 41 with only the first audio output device 41 as an output destination. In addition, the control circuit 10D controls the second wireless communication circuit 32E to output the second audio to the second audio output device 42 with only the second audio output device 42 as an output destination.

Then, in a case where it is determined that the first video/audio and the second video/audio are the same video/audio, it is sufficient if the control circuit 10D controls the first wireless communication circuit 31E to output the first audio to both the first audio output device 41 and the second audio output device 42 with both the first audio output device 41 and the second audio output device 42 as the output destinations.

The first wireless communication circuit 31E and the second wireless communication circuit 32E can use both the multicast protocol and the broadcast protocol, and may be able to output the audio to the audio output device 40 by multicasting or broadcasting. In this case, before it is determined that the first video and the second video are the same video, that is, in the initial state, the control circuit 10D controls the first wireless communication circuit 31E to output the first audio to the first audio output device 41 by multicasting with only the first audio output device 41 as the output destination. In addition, the control circuit 10D controls the second wireless communication circuit 32E to output the second audio to the second audio output device 42 by multicasting with only the second audio output device 42 as the output destination. Then, in a case where it is determined that the first video/audio and the second video/audio are the same video/audio, the control circuit 10D may control the first wireless communication circuit 31E to output the first audio to both the first audio output device 41 and the second audio output device 42 by broadcasting.

With such controls, in a case where it is determined that the first video/audio and the second video/audio are the same video/audio, the control circuit 10D operates the second wireless communication circuit 32E in the power saving mode, and controls the first wireless communication circuit 31E to output the first audio to the first audio output device 41 and the second audio output device 42.

Then, the control circuit 10D controls the first output circuit 10E to output the first video to the first display region D1, and controls the second output circuit 10G to output the second video to the second display region D2. That is, the first output circuit 10E outputs the first video to the first display region D1 of one or more display devices 30, and the second output circuit 10G outputs the second video to the second display region D2 of one or more display devices 30.

In the present embodiment, the first output circuit 10E outputs the first video to the first display region D1 of the first display panel 31F of the first display device 31. The second output circuit 10G outputs the second video to the second display region D2 of the second display panel 32F of the second display device 32 (see also FIG. 1).

Specifically, when the first video/audio is received from the first output circuit 10E of the information processing device 10 via the first input circuit 31A, the first display device control circuit 31C of the first display device 31 outputs the first video included in the first video/audio to the first display region D1 of the first display panel 31F. When the second video/audio is received from the first output circuit 10E via the second input circuit 32A, the second display device control circuit 32C of the second display device 32 outputs the second video included in the second video/audio to the second display region D2 of the second display panel 32F. Therefore, as illustrated in FIG. 1, the first video is displayed in the first display region D1 of the first display panel 31F, and the second video is displayed in the second display region D2 of the second display panel 32F. In a case where the first video/audio and the second video/audio are the same video/audio, the same video is displayed in the first display region D1 and the second display region D2.

On the other hand, in a case where it is determined that the first video/audio and the second video/audio are different video/audios, the control circuit 10D controls the first wireless communication circuit 31E to output the first audio to the first audio output device 41, and controls the second wireless communication circuit 32E to output the second audio to the second audio output device 42.

In a case where it is determined that the first video/audio and the second video/audio are different video/audios and determines that the second wireless communication circuit 32E is in the power saving mode, it is sufficient if the control circuit 10D performs control to cancel the power saving mode of the second wireless communication circuit 32E and then controls the second wireless communication circuit 32E to output the second audio to the second audio output device 42.

Similarly to the above, it is assumed that the priority information indicating the priority degree of the wireless communication circuit that is the wireless communication connection target is registered in advance in each of the first audio output device 41 and the second audio output device 42. Similarly to the above, it is assumed that the wireless communication circuit identification information for identifying the first wireless communication circuit 31E is registered in the first audio output device 41 in association with the first priority information, and the wireless communication circuit identification information for identifying the second wireless communication circuit 32E is registered in advance in association with the second priority information indicating the next priority. In addition, it is assumed that the wireless communication circuit identification information for identifying the second wireless communication circuit 32E is registered in the second audio output device 42 in association with the first priority information, and the wireless communication circuit identification information for identifying the first wireless communication circuit 31E is registered in advance in association with the second priority information indicating the next priority.

In this case, when the power saving mode of the second wireless communication circuit 32E is canceled and the output of the second audio from the second wireless communication circuit 32E by wireless communication starts, the second audio output device 42 receives the second audio from the second wireless communication circuit 32E identified by the wireless communication circuit identification information associated with the priority degree information indicating a higher priority. In addition, the first audio output device 41 receives the first audio from the first wireless communication circuit 31E identified by the wireless communication circuit identification information associated with the priority degree information indicating a higher priority.

Therefore, in a case where the priority information is registered in advance in the audio output device 40, the control circuit 10D can control the first wireless communication circuit 31E to output the first audio included in the first video/audio to the first audio output device 41 and can control the second wireless communication circuit 32E to output the second audio included in the second video/audio to the second audio output device 42 by canceling the power saving mode of the second wireless communication circuit 32E. That is, in a case where the priority information is registered in advance in the audio output device 40, the control circuit 10D can control each of the first wireless communication circuit 31E and the second wireless communication circuit 32E to output the first audio to the first audio output device 41 and output the second audio to the second audio output device 42 by simple control.

A mode in which the priority information indicating the priority degree of the wireless communication circuit that is the wireless communication connection target is not registered in advance in each of the first audio output device 41 and the second audio output device 42 similarly to the above is also applicable.

In this case, in a case where it is determined that the first video/audio and the second video/audio are different video/audios, the control circuit 10D transmits, to each of the first display device 31 and the second display device 32, the control information for performing control to output the first audio from the first wireless communication circuit 31E to the first audio output device 41 and output the second audio from the second wireless communication circuit 32E to the second audio output device 42.

Specifically, the control circuit 10D transmits, to the first display device 31 via the control information output circuit 10F, a control signal indicating that the first audio is to be output to the first audio output device 41 with only the first audio output device 41 as the output destination. It is sufficient if the first display device control circuit 31C that has received the control signal via the first control information input circuit 31B controls the first wireless communication circuit 31E to output the first audio to the first audio output device 41 with only the first audio output device 41 as the output destination. In addition, the control circuit 10D transmits, to the second display device 32 via the control information output circuit 10F, a control signal indicating that the second audio is to be output to the second audio output device 42 with only the second audio output device 42 as the output destination. It is sufficient if the second display device control circuit 32C that has received the control signal via the second control information input circuit 32B controls the second wireless communication circuit 32E to output the second audio to the second audio output device 42 with only the second audio output device 42 as the output destination.

With such controls, in a case where it is determined that the first video/audio and the second video/audio are different video/audios, the control circuit 10D controls the first wireless communication circuit 31E to output the first audio to the first audio output device 41, and controls the second wireless communication circuit 32E to output the second audio to the second audio output device 42.

Then, the control circuit 10D controls the first output circuit 10E to output the first video to the first display region D1, and controls the second output circuit 10G to output the second video to the second display region D2. That is, the first output circuit 10E outputs the first video to the first display region D1 of the first display device 31, and the second output circuit 10G outputs the second video to the second display region D2 of the second display device 32. Therefore, as illustrated in FIG. 1, the first video is displayed in the first display region D1 of the first display panel 31F, and the second video is displayed in the second display region D2 of the second display panel 32F. In a case where the first video/audio and the second video/audio are different video/audios, different videos are displayed in the first display region D1 and the second display region D2.

The control circuit 10D may determine whether the system 1 is in a first power state or a second power state, and determine whether or not the first video/audio and the second video/audio are the same video/audio in a case where it is determined that the system 1 is in the first power state.

The first power state means that the first wireless communication circuit 31E is in an on state in which the power is supplied and the second wireless communication circuit 32E is in an off state in which the supply of the power is cut off. In the present embodiment, a mode in which the first wireless communication circuit 31E is mounted on the first display device 31 and the second wireless communication circuit 32E is mounted on the second display device 32 will be described as an example. Therefore, the present embodiment will be described assuming a case where the first power state indicates a state in which the first display device 31 is in the on state in which the power is supplied and the second display device 32 is in the off state in which the supply of the power is cut off.

The second power state means an on state in which the power is supplied to both the first wireless communication circuit 31E and the second wireless communication circuit 32E. In the present embodiment, a mode in which the first wireless communication circuit 31E is mounted on the first display device 31 and the second wireless communication circuit 32E is mounted on the second display device 32 will be described as an example. Therefore, the present embodiment will be described assuming a case where the second power state indicates a state in which both the first display device 31 and the second display device 32 are in the on state in which the power is supplied.

For example, the control circuit 10D transmits control information indicating an inquiry about a power supply state to each of the first display device 31 and the second display device 32 via the control information output circuit 10F. Then, in a case where the control circuit 10D receives a response signal indicating the on state from the first display device 31 within a predetermined time for the control information, and does not receive a response signal indicating the on state from the second display device 32 or receives a response signal indicating the off state from the second display device 32 within the predetermined time, the control circuit 10D determines that the power state is the first power state.

In addition, for example, the control circuit 10D transmits the control information indicating the inquiry about the power supply state to each of the first display device 31 and the second display device 32 via the control information output circuit 10F. Then, in a case where the control circuit 10D receives the response signal indicating the on state from the first display device 31 within the predetermined time for the control information and receives the response signal indicating the on state from the second display device 32 within the predetermined time, the control circuit 10D determines that the power state is the second power state.

In a case where it is determined that the power state is the second power state, it is sufficient if the control circuit 10D determines whether or not the first video/audio and the second video/audio are the same video/audio, and execute processing similar to the above.

In a case where it is determined that the power state is the first power state, it is sufficient if the control circuit 10D controls the first wireless communication circuit 31E to output the first audio to the first audio output device 41 and the second audio output device 42. It is sufficient if a method similar to the above may be used as a method for controlling the first wireless communication circuit 31E to output the first audio to the first audio output device 41 and the second audio output device 42. It is sufficient if the control circuit 10D controls the first output circuit 10E to output the first video included in the first video/audio to the first display region D1 in a manner similar to the above.

In a case where it is determined that the power state of the system 1 has been switched from the first power state to the second power state, it is sufficient if the control circuit 10D determines whether or not the first video/audio and the second video/audio are the same video/audio and execute processing similar to the above.

Next, an example of a flow of the information processing executed by the information processing device 10 according to the present embodiment will be described.

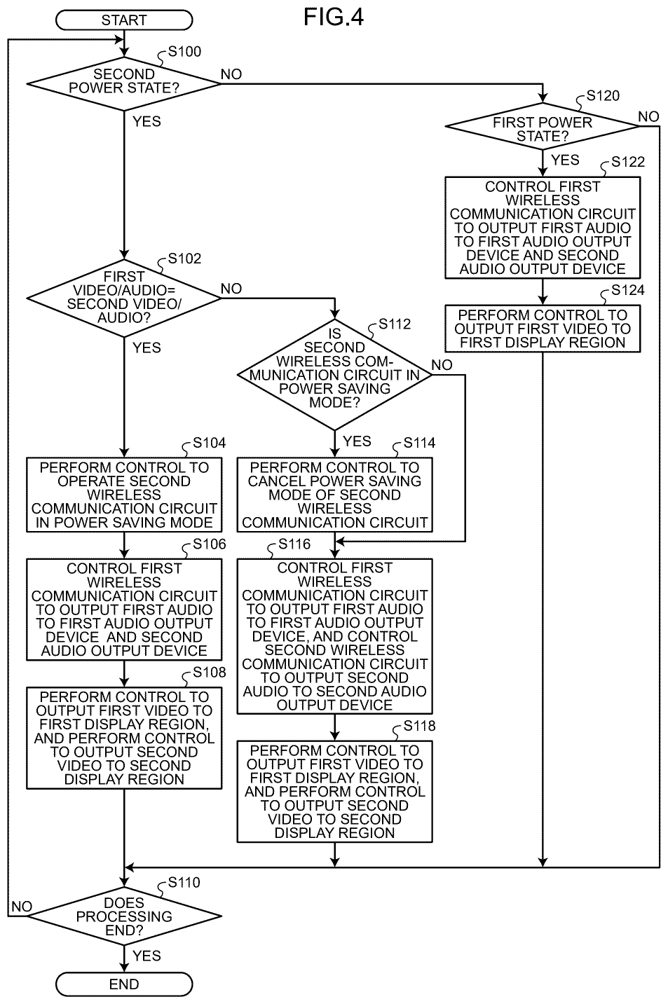

FIG. 4 is a flowchart illustrating an example of the flow of the information processing executed by the information processing device 10 according to the present embodiment. In FIG. 4, the description is given assuming a case where the control circuit 10D acquires the first video/audio and the second video/audio as the video/audios to be output to the display devices 30 is assumed.

The control circuit 10D determines whether or not the system 1 is in the second power state (Step S100). When it is determined that the system 1 is in the second power state (Step S100: Yes), the processing proceeds to Step S102.

In Step S102, the control circuit 10D determines whether or not the first video/audio and the second video/audio to be output are the same video/audio (Step S102).

When the control circuit 10D determines that the first video/audio and the second video/audio are the same video/audio (Step S102: Yes), the processing proceeds to Step S104.

In Step S104, the control circuit 10D operates the second wireless communication circuit 32E in the power saving mode (Step S104). For example, the control circuit 10D outputs the control signal indicating that the second wireless communication circuit 32E is to operate in the power saving mode to the second control information input circuit 32B via the control information output circuit 10F (Step S104). By the processing in Step S104, the wireless communication connection between the second wireless communication circuit 32E and the second audio output device 42 is released, and the output of the second audio from the second wireless communication circuit 32E to the second audio output device 42 is stopped.

In addition, the control circuit 10D controls the first wireless communication circuit 31E to output the first audio to the first audio output device 41 and the second audio output device 42 (Step S106). By the processing in Step S106, the first audio is output from the first wireless communication circuit 31E to the first audio output device 41 and second audio output device 42 by wireless communication.

The control circuit 10D controls the first output circuit 10E to output the first video to the first display region D1, and controls the second output circuit 10G to output the second video to the second display region D2 (Step S108). By the processing in Step S108, the first video is output to the first display region D1 of the first display panel 31F of the first display device 31, and the second video is output to the second display region D2 of the second display panel 32F of the second display device 32.

Next, the control circuit 10D determines whether or not to end the processing (Step S110). For example, the control circuit 10D performs the determination of Step S110 by determining whether or not an instruction signal indicating the end of the processing has been received by an operation instruction or the like from the user. In addition, the control circuit 10D may perform the determination in Step S110 by determining whether or not an instruction signal indicating the cut off of the supply of the power to the system 1 has been received. When a negative determination is made in Step S110 (Step S110: No), the processing returns to Step S100. When an affirmative determination is made in Step S110 (Step S110: Yes), this routine ends.

On the other hand, when the control circuit 10D determines in Step S102 that the first video/audio and the second video/audio are different video/audios (Step S102: No), the processing proceeds to Step S112.

In Step S112, the control circuit 10D determines whether or not the second wireless communication circuit 32E is in the power saving mode (Step S112). When the control circuit 10D makes a negative determination in Step S112 (Step S112: No), the processing proceeds to Step S116 described below. When the control circuit 10D makes an affirmative determination in Step S112 (Step S112: Yes), the processing proceeds to Step S114.

In Step S114, the control circuit 10D performs control to cancel the power saving mode of the second wireless communication circuit 32E (Step S114). Then, the processing proceeds to Step S116.

In Step S116, the control circuit 10D controls the first wireless communication circuit 31E to output the first audio to the first audio output device 41, and controls the second wireless communication circuit 32E to output the second audio to the second audio output device 42 (Step S116). By the processing in Step S116, the first audio is output from the first wireless communication circuit 31E to the first audio output device 41 by wireless communication, and the second audio is output from the second wireless communication circuit 32E to the second audio output device 42 by wireless communication.

The control circuit 10D controls the first output circuit 10E to output the first video to the first display region D1, and controls the second output circuit 10G to output the second video to the second display region D2 (Step S118). By the processing in Step S118, the first video is output to the first display region D1 of the first display panel 31F of the first display device 31, and the second video is output to the second display region D2 of the second display panel 32F of the second display device 32. Then, the processing proceeds to Step S110 described above.

On the other hand, when a negative determination is made in Step S100 (Step S100: No), the processing proceeds to Step S120. In Step S120, the control circuit 10D determines whether or not the power state of the system 1 is the first power state (Step S120). When a negative determination is made in Step S120 (Step S120: No), the processing proceeds to Step S110. When an affirmative determination is made in Step S120 (Step S120: Yes), the processing proceeds to Step S122.

In Step S122, the control circuit 10D controls the first wireless communication circuit 31E to output the first audio to the first audio output device 41 and the second audio output device 42 (Step S122). Therefore, in a case where the power state is the first power state in which the first wireless communication circuit 31E is in the on state in which the power is supplied and the second wireless communication circuit 32E is in the off state in which the supply of the power is cut off, the first audio is output from the first wireless communication circuit 31E to the first audio output device 41 and the second audio output device 42 by wireless communication.

The control circuit 10D controls the first output circuit 10E to output the first video included in the first video/audio to the first display region D1 (Step S124). Then, the processing proceeds to Step S110.

As described above, the information processing device 10 according to the present embodiment includes the first output circuit 10E, the second output circuit 10G, and the control circuit 10D. The first output circuit 10E outputs the first video included in the first video/audio to the first display region D1, and outputs the first audio included in the first video/audio to the first wireless communication circuit 31E that outputs the audio to the first audio output device 41 by wireless communication. The second output circuit 10G outputs the second video included in the second video/audio to the second display region D2, and outputs the second audio included in the second video/audio to the second wireless communication circuit 32E that outputs the audio to the second audio output device 42 by wireless communication. In a case where it is determined that the first video/audio and the second video/audio are the same video/audio, the control circuit 10D operates the second wireless communication circuit 32E in the power saving mode.

As described above, in a case where it is determined that the first video/audio and the second video/audio are the same video/audio, the information processing device 10 according to the present embodiment causes the second wireless communication circuit 32E that outputs the second audio included in the second video/audio to the second audio output device 42 by wireless communication to be in the power saving mode. Therefore, it is possible to avoid operating both the first wireless communication circuit 31E and the second wireless communication circuit 32E, which are a plurality of wireless communication circuits that output the audio to the audio output devices 40 by wireless communication in order to output the same audio.

Therefore, the information processing device 10 according to the present embodiment can reduce power consumption of the system 1.

### First Modified Example

In the above embodiment, a mode in which, in a case where it is determined that the first video/audio and the second video/audio are the same video/audio, the control circuit 10D operates the second wireless communication circuit 32E in the power saving mode, controls the first wireless communication circuit 31E to output the first audio to the first audio output device 41 and the second audio output device 42, and performs control to output the first video to the first display region D1 and output the second video to the second display region D2 has been described as an example.

However, in a case where the input of any one of the first video/audio and the second video/audio is stopped, the control circuit 10D may operate the second wireless communication circuit 32E in the power saving mode and further control the first wireless communication circuit 31E to output the first audio to the first audio output device 41 and the second audio output device 42. Furthermore, at this time, the control circuit 10D may perform control to output the first video to at least one of the first display region D1 and the second display region D2.

### Second Modified Example

In the above embodiment, a mode in which a first display device 33 included in the system 1 includes the first wireless communication circuit 31E and the second display device 32 includes the second wireless communication circuit 32E has been described as an example. However, at least one of the first wireless communication circuit 31E and the second wireless communication circuit 32E may be provided in the information processing device 10. Furthermore, at least one of the first wireless communication circuit 31E and the second wireless communication circuit 32E may be provided in an external device such as the display device 30 communicably connected to the information processing device 10.

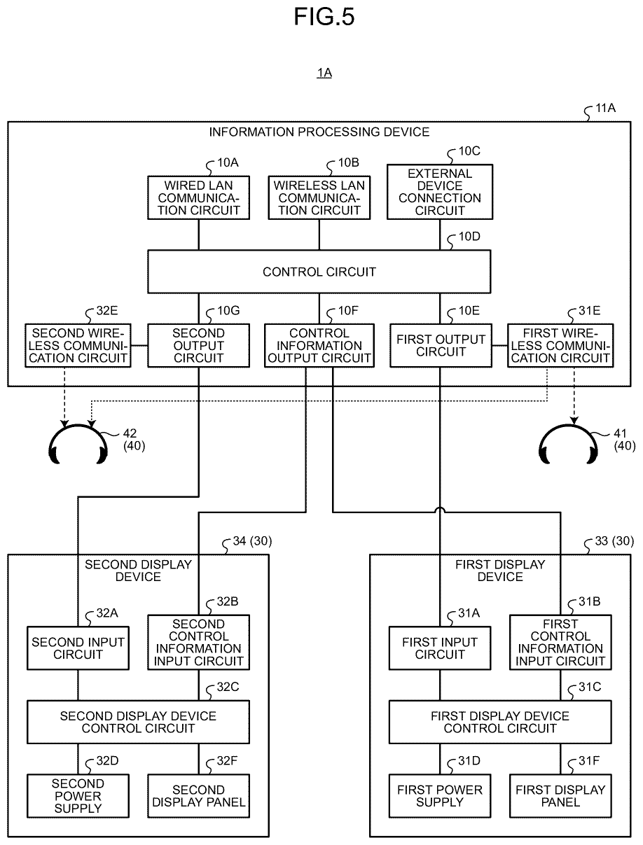

FIG. 5 is a schematic diagram illustrating an example of a system 1A according to the present modified example. The system 1A includes an information processing device 11A, a second display device 34, a first display device 33, a first audio output device 41, and a second audio output device 42.

The information processing device 11A is similar to the information processing device 10 according to the above embodiment except that the information processing device 11A further includes a first wireless communication circuit 31E and a second wireless communication circuit 32E. In the present embodiment, it is sufficient if the first wireless communication circuit 31E of the information processing device 11A is communicably connected to a first output circuit 10E, and the second wireless communication circuit 32E is communicably connected to a second output circuit 10G.

The first display device 33 and the second display device 34 are examples of a display device 30. The first display device 33 is similar to the first display device 31 according to the above embodiment except that the first wireless communication circuit 31E is not provided. The second display device 34 is similar to the second display device 32 according to the above embodiment except that the second wireless communication circuit 32E is not provided.

As illustrated in FIG. 5, the information processing device 11A may include the first wireless communication circuit 31E and the second wireless communication circuit 32E.

Furthermore, the information processing device 11A may include any one of the first wireless communication circuit 31E and the second wireless communication circuit 32E, and the other may be provided in an external device such as the display device 30 communicably connected to the information processing device 11A.

### Third Modified Example

In the above embodiment, a mode in which the system 1 includes the first display device 31 and the second display device 32 has been described as an example. However, the system 1 only needs to have a configuration including one or more display devices 30, and may have a configuration including one display device 30.

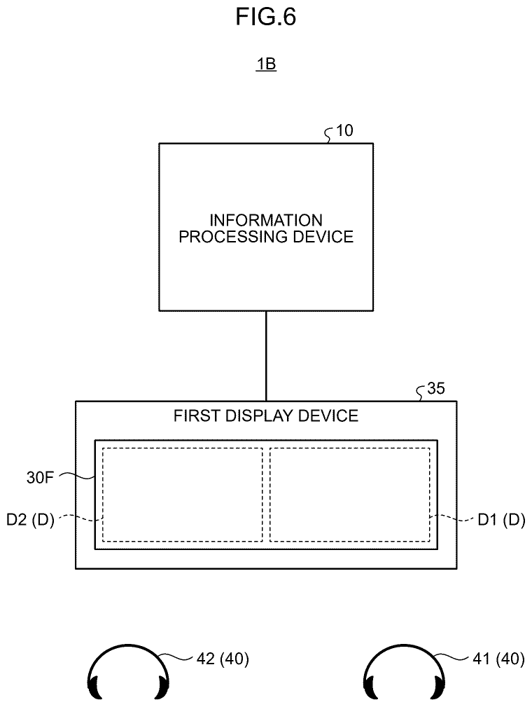

FIG. 6 is a schematic diagram illustrating an example of a system 1B according to the present modified example. The system 1B includes an information processing device 10, a first display device 35, and audio output devices 40. The information processing device 10 and the first display device 35 are communicably connected to each other. At least one of the information processing device 10 and the first display device 35 is communicably connected to the audio output devices 40 by wireless communication.

The first display device 35 is an example of the display device 30. In the present modified example, the first display device 35 includes at least a display panel 30F that displays various videos. The video is displayed in one display region D of the display panel 30F, or in each of a first display region D1 and a second display region D2 of the display panel 30F.

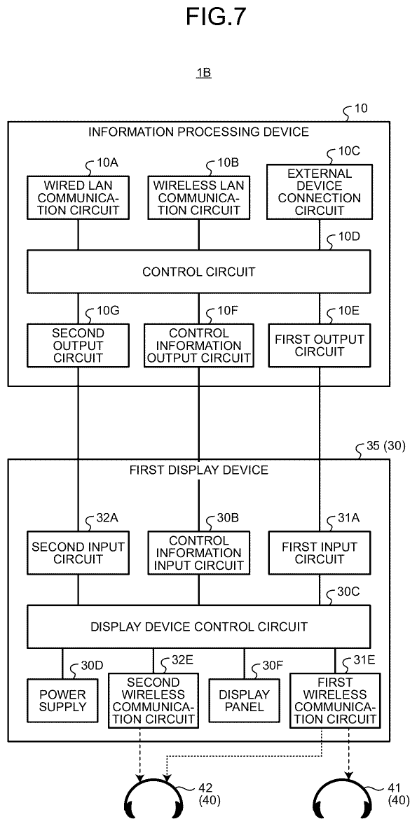

FIG. 7 is a block diagram illustrating an example of a functional configuration of the system 1B.

The system 1B includes the information processing device 10, the first display device 35, a first audio output device 41, and a second audio output device 42. The information processing device 10 and the first display device 35 are communicably connected to each other.

The first display device 35 includes a first input circuit 31A, a control information input circuit 30B, a display device control circuit 30C, a power supply 30D, a first wireless communication circuit 31E, a second wireless communication circuit 32E, and the display panel 30F.

The first input circuit 31A, the second input circuit 32A, the control information input circuit 30B, the power supply 30D, the first wireless communication circuit 31E, the second wireless communication circuit 32E, and the first display panel 31F are connected to the display device control circuit 30C so as to be able to exchange data or a signal.

The first input circuit 31A, the second input circuit 32A, the second wireless communication circuit 32E, and the first wireless communication circuit 31E are similar to those in the above embodiment. The control information input circuit 30B corresponds to the first control information input circuit 31B and the second control information input circuit 32B according to the above embodiment. The display device control circuit 30C corresponds to the first display device control circuit 31C and the second display device control circuit 32C according to the above embodiment. The power supply 30D supplies power to each unit of the first display device 35. The display panel 30F is a display such as a liquid crystal display or an organic EL display.

In the present modified example, the first display device 35 includes the first display region D1 and the second display region D2. Specifically, as illustrated in FIG. 6, the first video is displayed in the first display region D1 of the display panel 30F, and the second video is displayed in the second display region D2 of the display panel 30F. In the present modified example, as illustrated in FIG. 7, it is sufficient if a second output circuit 10G of the information processing device 10 outputs the first video to the first display region D1 of the first display device 35, and outputs the second video to the second display region D2 of the first display device 35.

Similarly to the second display device control circuit 32C and the first display device control circuit 31C according to the above embodiment, it is sufficient if the display device control circuit 30C controls the first wireless communication circuit 31E, the second wireless communication circuit 32E, and the display panel 30F according to control information received from the information processing device 10.

Similarly to the above embodiment, in a case where a control circuit 10D of the information processing device 10 included in the system 1B determines that the first video/audio and the second video/audio are the same video/audio, it is sufficient if the control circuit 10D operates the second wireless communication circuit 32E in the power saving mode and controls the first wireless communication circuit 31E to output the first audio to the first audio output device 41 and the second audio output device 42. In addition, the control circuit 10D of the information processing device 10 included in the system 1B may perform control to output the first video to the first display region D1 of the display panel 30F, and output the second video to the second display region D2 of the display panel 30F.

Similarly to the first modified example described above, in a case where the input of any one of the first video/audio and the second video/audio is stopped, the control circuit 10D of the information processing device 10 included in the system 1B may operate the second wireless communication circuit 32E in the power saving mode and further control the first wireless communication circuit 31E to output the first audio to the first audio output device 41 and the second audio output device 42. At this time, the control circuit 10D may perform control to output the first video to the display region D of the display panel 30F.

### Fourth Modified Example

In the third modified example, a mode in which the first display device 35 included in the system 1B includes the first wireless communication circuit 31E and the second wireless communication circuit 32E has been described as an example. However, at least one of the first wireless communication circuit 31E and the second wireless communication circuit 32E may be provided in the information processing device 10.

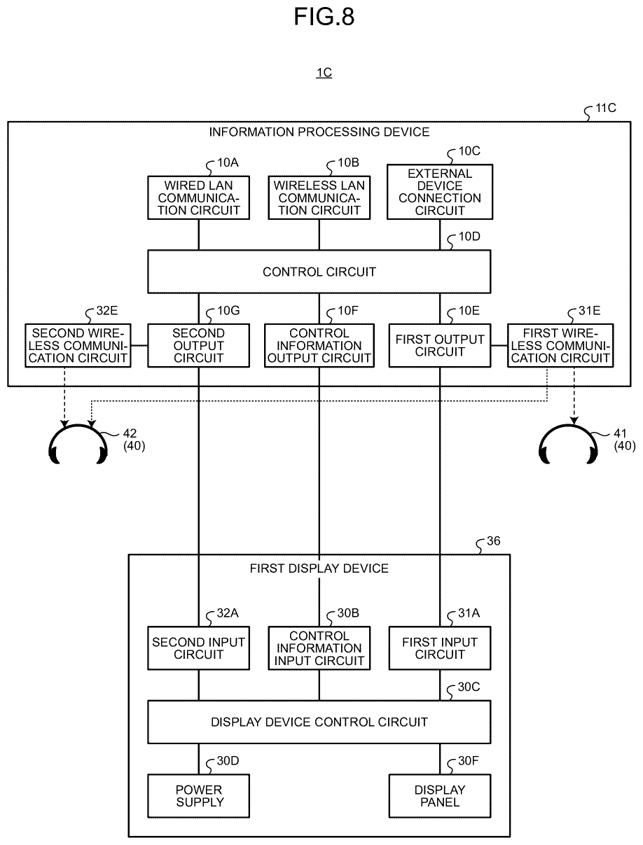

FIG. 8 is a schematic diagram illustrating an example of a system 1C according to the present modified example. The system 1C includes an information processing device 11C, a first display device 36, a first audio output device 41, and a second audio output device 42.

The information processing device 11C is similar to the information processing device 10 according to the third modified example described above except that the information processing device 11C further includes a first wireless communication circuit 31E and a second wireless communication circuit 32E. In the present modified example, it is sufficient if the first wireless communication circuit 31E of the information processing device 11C is communicably connected to a first output circuit 10E, and the second wireless communication circuit 32E is communicably connected to a second output circuit 10G.

The first display device 36 is an example of the display device 30. The first display device 36 is similar to the first display device 35 according to the third modified example except that the first wireless communication circuit 31E and the second wireless communication circuit 32E are not provided.

As illustrated in FIG. 8, the information processing device 11C may include the first wireless communication circuit 31E and the second wireless communication circuit 32E.

Furthermore, the information processing device 11C may include any one of the first wireless communication circuit 31E and the second wireless communication circuit 32E, and the other may be provided in the first display device 36 communicably connected to the information processing device 11C.

The present technology can also have the following configurations.

(1) An information processing device includes:
a first output circuit configured to output a first video included in a first video/audio to a first display region, and output a first audio included in the first video/audio to a first wireless communication circuit that outputs an audio to a first audio output device by wireless communication;
a second output circuit configured to output a second video included in a second video/audio to a second display region, and output a second audio included in the second video/audio to a second wireless communication circuit that outputs an audio to a second audio output device by wireless communication; and
a control circuit configured to operate the second wireless communication circuit in a power saving mode when it is determined that the first video/audio and the second video/audio are a same video/audio.

(2) In the information processing device according to (1), the control circuit is configured to operate the second wireless communication circuit in the power saving mode by stopping at least the output of the audio.

(3) In the information processing device according to (1) or (2), the control circuit is configured to:
operate the second wireless communication circuit in the power saving mode when it is determined that the first video/audio and the second video/audio are the same video/audio; and
control the first wireless communication circuit to output the first audio to the first audio output device and the second audio output device.

(4) The information processing device according to any one of (1) to (3), further includes:
at least one of the first wireless communication circuit and the second wireless communication circuit.

(5) In the information processing device according to any one of (1) to (4), at least one of the first wireless communication circuit and the second wireless communication circuit is provided in an external device communicably connected to the information processing device.

(6) In the information processing device according to any one of (1) to (5), one or more display devices include the first display region and the second display region,
the first output circuit is configured to output the first video to the first display region, and
the second output circuit is configured to output the second video to the second display region.

(7) In the information processing device according to (6), the one or more display devices include a first display device, and
the first display device includes the first display region and the second display region.

(8) In the information processing device according to (6), the one or more display devices include a first display device and a second display device,
the first display device includes the first display region, and
the second display device includes the second display region.

(9) In the information processing device according to (8), the first display device includes the first wireless communication circuit, and
the second display device includes the second wireless communication circuit.

(10) In the information processing device according to any one of (1) to (9), when the second audio is not receivable from the second wireless communication circuit identified by wireless communication circuit identification information associated with priority degree information indicating a higher priority degree,
the second audio output device is configured to receive the first audio from the first wireless communication circuit identified by wireless communication circuit identification information associated with priority degree information indicating a lower priority degree.

(11) In the information processing device according to any one of (1) to (10), when it is determined that the first video/audio and the second video/audio are different video/audios,
the control circuit is configured to:
control the first wireless communication circuit to output the first audio to the first audio output device; and
control the second wireless communication circuit to output the second audio to the second audio output device.

(12) In the information processing device according to any one of (1) to (11), when it is determined that a power state is a first power state in which the first wireless communication circuit is in an on state in which power is supplied and the second wireless communication circuit is in an off state in which supply of power is cut off,
the control circuit is configured to control the first wireless communication circuit to output the first audio to the first audio output device and the second audio output device, and
when it is determined that the power state is switched from the first power state to a second power state in which the first wireless communication circuit and the second wireless communication circuit are in the on state, and it is determined that the first video/audio and the second video/audio are different video/audios,
the control circuit is configured to control the first wireless communication circuit to output the first audio to the first audio output device, and control the second wireless communication circuit to output the second audio to the second audio output device.

(13) In the information processing device according to any one of (1) to (12), when it is determined that a power state is a first power state in which the first wireless communication circuit is in an on state in which power is supplied and the second wireless communication circuit is in an off state in which supply of power is cut off,
the control circuit is configured to control the first wireless communication circuit to output the first audio to the first audio output device and the second audio output device, and
when it is determined that the power state is switched from the first power state to a second power state in which the first wireless communication circuit and the second wireless communication circuit are in the on state, and it is determined that the first video/audio and the second video/audio are the same video/audio,
the control circuit is configured to operate the second wireless communication circuit in the power saving mode and control the first wireless communication circuit to output the first audio to the first audio output device and the second audio output device.

(14) An information processing method executed by an information processing device including:
a first output circuit configured to output a first video included in a first video/audio to a first display region, and output a first audio included in the first video/audio to a first wireless communication circuit that outputs an audio to a first audio output device by wireless communication; and
a second output circuit configured to output a second video included in a second video/audio to a second display region, and output a second audio included in the second video/audio to a second wireless communication circuit that outputs an audio to a second audio output device by wireless communication, the method includes:
operating the second wireless communication circuit in a power saving mode when it is determined that the first video/audio and the second video/audio are a same video/audio.

With the information processing device and the information processing method according to the present disclosure, power consumption can be reduced.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a first output circuit configured to output a first video included in a first video/audio to a first display region, and output a first audio included in the first video/audio to a first wireless communication circuit that outputs an audio to a first audio output device by wireless communication;
a second output circuit configured to output a second video included in a second video/audio to a second display region, and output a second audio included in the second video/audio to a second wireless communication circuit that outputs an audio to a second audio output device by wireless communication; and
a control circuit configured to operate the second wireless communication circuit in a power saving mode when it is determined that the first video/audio and the second video/audio are a same video/audio.

2. The information processing device according to claim 1, wherein
the control circuit is configured to operate the second wireless communication circuit in the power saving mode by stopping at least the output of the audio.

3. The information processing device according to claim 1, wherein
the control circuit is configured to:
operate the second wireless communication circuit in the power saving mode when it is determined that the first video/audio and the second video/audio are the same video/audio; and
control the first wireless communication circuit to output the first audio to the first audio output device and the second audio output device.

4. The information processing device according to claim 1, further comprising:
at least one of the first wireless communication circuit and the second wireless communication circuit.

5. The information processing device according to claim 1, wherein
at least one of the first wireless communication circuit and the second wireless communication circuit is provided in an external device communicably connected to the information processing device.

6. The information processing device according to claim 1, wherein
one or more display devices include the first display region and the second display region,
the first output circuit is configured to output the first video to the first display region, and
the second output circuit is configured to output the second video to the second display region.

7. The information processing device according to claim 6, wherein
the one or more display devices include a first display device, and
the first display device includes the first display region and the second display region.

8. The information processing device according to claim 6, wherein
the one or more display devices include a first display device and a second display device,
the first display device includes the first display region, and
the second display device includes the second display region.

9. The information processing device according to claim 8, wherein
the first display device includes the first wireless communication circuit, and
the second display device includes the second wireless communication circuit.

10. The information processing device according to claim 1, wherein
when the second audio is not receivable from the second wireless communication circuit identified by wireless communication circuit identification information associated with priority degree information indicating a higher priority degree,
the second audio output device is configured to receive the first audio from the first wireless communication circuit identified by wireless communication circuit identification information associated with priority degree information indicating a lower priority degree.

11. The information processing device according to claim 1, wherein
when it is determined that the first video/audio and the second video/audio are different video/audios,
the control circuit is configured to:
control the first wireless communication circuit to output the first audio to the first audio output device; and
control the second wireless communication circuit to output the second audio to the second audio output device.

12. The information processing device according to claim 1, wherein
when it is determined that a power state is a first power state in which the first wireless communication circuit is in an on state in which power is supplied and the second wireless communication circuit is in an off state in which supply of power is cut off,
the control circuit is configured to control the first wireless communication circuit to output the first audio to the first audio output device and the second audio output device, and
when it is determined that the power state is switched from the first power state to a second power state in which the first wireless communication circuit and the second wireless communication circuit are in the on state, and it is determined that the first video/audio and the second video/audio are different video/audios,
the control circuit is configured to control the first wireless communication circuit to output the first audio to the first audio output device, and control the second wireless communication circuit to output the second audio to the second audio output device.

13. The information processing device according to claim 1, wherein
when it is determined that a power state is a first power state in which the first wireless communication circuit is in an on state in which power is supplied and the second wireless communication circuit is in an off state in which supply of power is cut off,
the control circuit is configured to control the first wireless communication circuit to output the first audio to the first audio output device and the second audio output device, and
when it is determined that the power state is switched from the first power state to a second power state in which the first wireless communication circuit and the second wireless communication circuit are in the on state, and it is determined that the first video/audio and the second video/audio are the same video/audio,
the control circuit is configured to operate the second wireless communication circuit in the power saving mode and control the first wireless communication circuit to output the first audio to the first audio output device and the second audio output device.

14. An information processing method executed by an information processing device including:
a first output circuit configured to output a first video included in a first video/audio to a first display region, and output a first audio included in the first video/audio to a first wireless communication circuit that outputs an audio to a first audio output device by wireless communication; and
a second output circuit configured to output a second video included in a second video/audio to a second display region, and output a second audio included in the second video/audio to a second wireless communication circuit that outputs an audio to a second audio output device by wireless communication, the method comprising:
operating the second wireless communication circuit in a power saving mode when it is determined that the first video/audio and the second video/audio are a same video/audio.

15. The information processing method according to claim 14, wherein
the operating includes operating the second wireless communication circuit in the power saving mode by stopping at least the output of the audio.

16. The information processing method according to claim 14, further comprising:
operating the second wireless communication circuit in the power saving mode when it is determined that the first video/audio and the second video/audio are the same video/audio; and
controlling the first wireless communication circuit to output the first audio to the first audio output device and the second audio output device.

17. The information processing method according to claim 14, further comprising:
when it is determined that the first video/audio and the second video/audio are different video/audios,
controlling the first wireless communication circuit to output the first audio to the first audio output device; and
controlling the second wireless communication circuit to output the second audio to the second audio output device.

18. The information processing method according to claim 14, further comprising:
when it is determined that a power state is a first power state in which the first wireless communication circuit is in an on state in which power is supplied and the second wireless communication circuit is in an off state in which supply of power is cut off,
controlling the first wireless communication circuit to output the first audio to the first audio output device and the second audio output device; and
when it is determined that the power state is switched from the first power state to a second power state in which the first wireless communication circuit and the second wireless communication circuit are in the on state, and it is determined that the first video/audio and the second video/audio are different video/audios,
controlling the first wireless communication circuit to output the first audio to the first audio output device, and controlling the second wireless communication circuit to output the second audio to the second audio output device.

19. The information processing method according to claim 14, further comprising:
when it is determined that a power state is a first power state in which the first wireless communication circuit is in an on state in which power is supplied and the second wireless communication circuit is in an off state in which supply of power is cut off,
controlling the first wireless communication circuit to output the first audio to the first audio output device and the second audio output device; and
when it is determined that the power state is switched from the first power state to a second power state in which the first wireless communication circuit and the second wireless communication circuit are in the on state, and it is determined that the first video/audio and the second video/audio are the same video/audio,
operating the second wireless communication circuit in the power saving mode and controlling the first wireless communication circuit to output the first audio to the first audio output device and the second audio output device.
